(19) United States
(12) Patent Application Publication
(10) Pub. No.: US 2004/0065616 A1
(43) Pub. Date: Apr. 8, 2004

(54) Method of desalination

(76) Inventor: Chau-Fu Shu, Taipei (TW)

Correspondence Address: Chau-Fu SHU, PO Box 82-144, TAIPEI, TW

(21) Appl. No.: 10/265,118

(22) Filed: Oct. 7, 2002

(51) Int. Cl. B01D 61/02; B01D 61/00

(52) U.S. Cl. 210/652; 210/121; 210/123; 210/257.2

(57) ABSTRACT

A method of desalination of sea water is disclosed and the method comprises the steps of drawing a stream of sea water into a supplying tank; passing a high pressure air via the top end of the supplying tank; delivering sea water to a pressure tank; and performing desalination via a plurality of reverse osmosis films.

### BACKGROUND OF THE INVENTION

(a) Technical Field of the Invention

The present invention relates to a desalination process, and in particular, a desalination used to desalify sea water.

(b) Description of the Prior Art

Taiwanese Patent Nos. 77339, 183373, 311588, 341523 relate to desalination of sea water. These methods make use of vaporization heat of sea water as the necessary exhaustive energy. However, the energy that used in this method requires heat energy from electrical power or the primary heat source. In the method of ions exchange, the water pressure of sea water is used to drive sea water to contact react with the ion exchanging agent to complete the desalination process. In Reverse Osmosis method (for instance in Taiwanese Patent No. 225088 and 353981, the osmosis pressure of sea water is used to accomplish the desalination process. However, the used water pressure is supplied by mechanical energy and the electrical energy and the initial energy source.

Apparently, these methods use a great amount of energy and require energy converting devices and therefore the cost of a desalination plant is very high and the desalinated water is very limited. Accordingly, it is an object of the present invention to provide a desalination method for sea water which overcomes the above drawbacks.

### SUMMARY OF THE INVENTION

Accordingly, it is an object of the present invention to provided a method of desalination of sea water comprising the steps of

(a) drawing a stream of sea water into a supplying tank;

(b) passing a high pressure air via the top end of the supplying tank;

(c) delivering sea water of step (a) to a pressure tank; and

(d) performing desalination via a plurality of reverse osmosis films.

Yet another aspect of the present invention is to provide n apparatus for desalination of sea water comprising a supplying tank, a pressure tank, a water pressure energy source and a plurality of reverse osmosis films, wherein the supply tank is provided with a venting valve and an air inlet valve at the top end of the supply tank and the bottom end of the supply tank is provided with a switch, the top end of the venting valve is in communication with the atmospheric pressure, and the top end of the inlet valve is connected to an air tube and is then connected to an air tube and then connected to a high pressure air supply source, the top end of the supplying tank is provided with a float and is secured to the wall of the tank with a support seat having an interlining rod so that the float can be swung, the top of the float is provided with a pressing block and when water in the tank is a full height, the air inlet valve allows air to enter so as to produce pressure, and the other end of the float is hooked with a sloping face hook and one end of the sloping face is secured at the top housing of tank wall by the support seat and the other end of the sloping face is connected to a rope having being connected to another float at the lower end of the tank, the float is secured to the tank wall at the bottom section by means of the support seat so that the float can be swung, when the water in the tank is lowered to the bottom section, the float will lower and the cable is pulled and the inter-linking rod is removed from the sloping face and the air valve is opened.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is flow chart showing energy conversion of the desalination method of the present invention.

FIG. 2 is a working flow chart of the desalination method of the present invention.

FIG. 3 is a sectional view of a sea water supplying tank of the present invention.

FIG. 4 is a float displacement control diagram of the supply tank of the present invention.

FIG. 5 is a cross-section view of the pneumatic tank of the present invention.

FIG. 6 is a float displacement control diagram of the pneumatic tank in accordance with the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

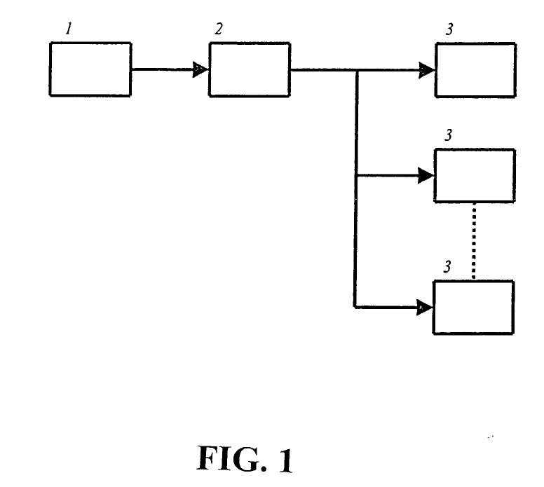

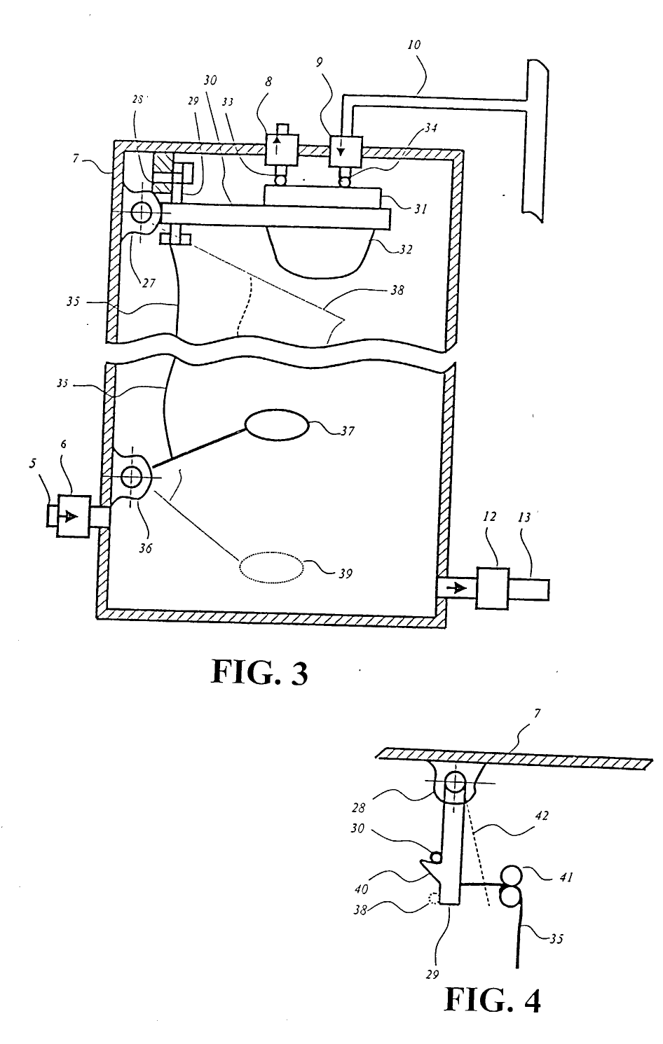

Referring to FIGS. 1 to 3, there is shown a desalination apparatus for desalination method in accordance with the present invention. The apparatus comprises a sea water tank 4, a supplying tank 7, and a pressure tank 18.

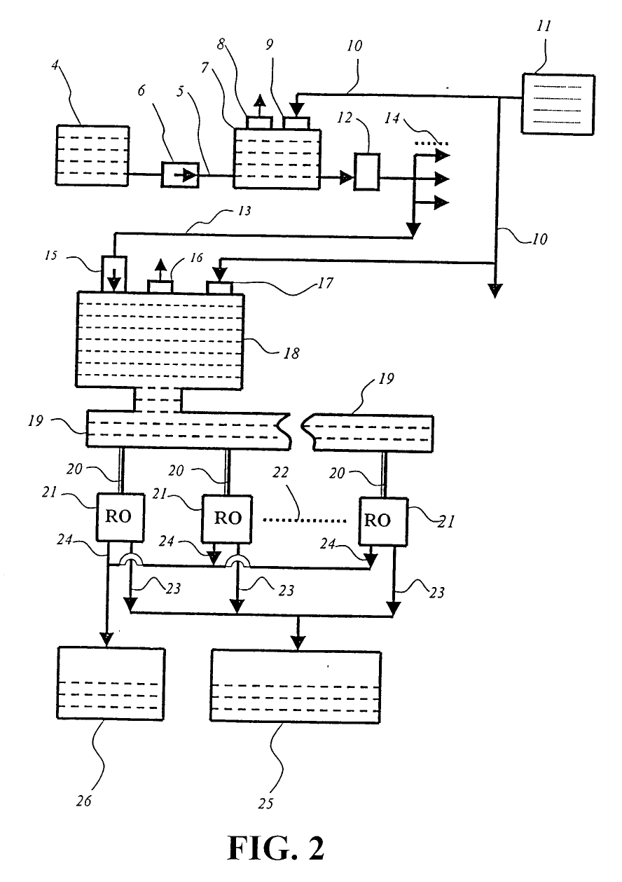

As shown in FIG. 2, the sea water tank 4 is connected using pipe 5 having a anti reverse flow valve 6 to the supply tank 7. The tank is provided with a venting valve 8 and an air inlet valve 9 and the venting velvet 8 is in communication with the atmosphere. The air inlet valve 9 is connected to an air tube 10 and then is connected to a high pressure air supply 11. The supplying tank 7 is connected to a filtering apparatus 12 and is connected to the anti-reverse flow valve 15 via a water pipe 13, and is then connected to a pressure tank 18. Extension 14 denotes the water pipe 13 being connected to other pressure tank 18. A venting valve and an air inlet valve are provided on the pressure tank 18, and the venting valve 16 is in communication with the atmosphere. The air inlet valve 17 is connected to an air tube 10 and then connected to a high pressure air supply. The pressure tank 18 is connected to the discharging tube 19 and one end of the water pipe 20 is connected to a discharging tube 19, and the other end of the water pipe 20 is connected to the reverse osmosis tube 21. The reverse osmosis tube 21 is provided with two outputs, one being a purified tube 23, and another being a waste water tube 24. The purified water tube is connected to a purified water tank 25, and the waste water tube 24 is connected to the waste water tank 26.

When the water in the supplying tank 7 is at a low level, the venting valve 8 will open and air inlet valve 9 will close. The pressure in the tank 7 will be similar to that of the atmosphere. When water enters the supply tank 7, and the water level has risen to the same level, and the water is at a high level position, the venting valve 8 will close and the air inlet valve 9 will open and therefore the high pressure air source 11 will pass through the air tube 10 into the supply tank. Therefore, the water in the tank 7 will be provided with water pressure energy and therefore water will flow to the filtering means 13, to the water pipe 13 and the valve 15 to the pressure tank 18.

In accordance with another preferred embodiment of the present invention, there is provided an apparatus for desalination of sea water comprising a supplying tank 7, a pressure tank 18, a water pressure energy source 1 and a plurality of reverse osmosis films, wherein the supply tank 7 is provided with a venting valve 8 and an air inlet valve 9 at the top end of the supply tank 7 and the bottom end of the supply tank 7 is provided with a switch 33, the top end of the venting valve 8 is in communication with the atmospheric pressure, and the top end of the inlet valve 9 is connected to an air tube and is then connected to a high pressure air supply source 10, the top end of the supplying tank 7 is provided with a float 32 and is secured to the wall of the tank 7 with a support seat 36 having an interlining rod 29 so that the float 32 can be swung, the top of the float 32 is provided with a pressing block 31 and when water in the tank 7 is a full height, the air inlet valve 9 allows air to enter so as to produce pressure, and the other end of the float 32 is hooked with a sloping face hook and one end of the sloping face 40 is secured at the top housing of tank wall by the support seat 36 and the other end of the sloping face 40 is connected to a rope 35 having being connected to another float 32 at the lower end of the tank 7, the float 32 is secured to the tank wall at the bottom section by means of the support seat 36 so that the float 32 can be swung, when the water in the tank is lowered to the bottom section, the float 32 will lower and the rope 35 is pulled and the inter-linking rod 29 is removed from the sloping face 40 and the air valve 17 is opened.

In accordance with the present invention, the pressure tank 18 is provided with a venting valve 16 and an air inlet valve 17, and the bottom end of the pressure tank 18 is provided with a switch 34, the top end of the venting valve 16 is in communication with the atmosphere, and the top end of the air inlet valve 17 is connected to an air tube 10 and is then connected to a high pressure air source, the top end of the pressure tank 18 is provided with an anti-reverse flow valve 15 to withdraw sea water to the supplying tank 7, the top end of the tank 7 is provided with a float 32 and the float 32 is secured to the tank wall by a support seat 36 having an inter-linking rod 29 so that the float 32 can be swung, the top of the float 32 is provided with a pressing block 31, thereby when the water in the tank 7 is at the full height position, the pressing block 31 triggers the valve having two air valves, and the air inlet valve 17 allows air to enter to produce a pressure, and at the same time, the inter-linking rod 29 of the float 32 is hooked by a sloping face 40, and one end of the sloping face 40 is secured to the top housing of the tank wall by a support seat 27, and the other end of the sloping face 40 is connected to a rope 35 and the rope 35 is then connected to another float 32 at the bottom end of the tank 7, and the float 32 is secured to the tank wall at the bottom section by the support seat 37 having an inter-linking rod 29 so that the float 32 can be swung, when the water in the tank 7 is lowered to the bottom section, the float 32 at the bottom section pulls the rope 35 and the sloping face 40 is removed so that the hooked inter-linking rod 30 is lowered and the air inlet valve 17 is released.

The present invention relates to a method of desalination of sea water comprising the steps of

(a) drawing a stream of sea water into a supplying tank;

(b) passing a high pressure air via the top end of the supplying tank;

(c) delivering sea water of step (a) to a pressure tank; and

(d) performing desalination via a plurality of reverse osmosis films.

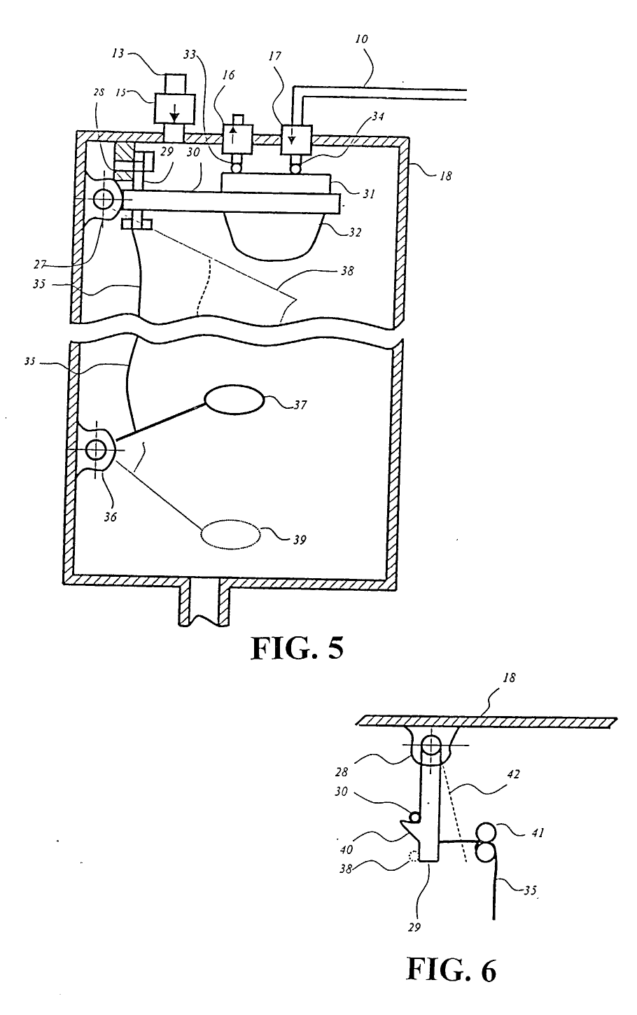

Referring to FIG. 5, one end of the inter-linking rod 30 is secured to the tank wall of the pressure tank 18 by a support seat so that the rod is swinging. The other end of the rod 30 has a float 32 connected to a pressing block 31. The pressing block 31 simultaneously deactivates switch 33 and switch 34. The air vent valve 16 and the air inlet valve 17 are secured at the outer housing of the pressure tank 18. Water enters the tank via the anti-reverse flow valve 6 and one end of the rope 35 is connected to the inter-linking rod 29 and the other end passes through a sliding seat 41 (shown in FIG. 6) and is connected to the float 37. One end of the float 37 is secured to the tank wall of the pressure tank 18 by a support seat 36 so that it can swing. Water in the pressure tank 18 flows out via a discharging tube 19.

When the water level in the pressure tank 18 has risen to the maximum level, the float 32 will be elevated and the inter-linking rod will push away the inter-linking rod 29 via the sloping face 40. When it passes the sloping face 40, the inter-linking rod will restore to its original state and the inter-linking rod 30 will be hooked by the sloping face 40 and the same time, the pressing block 31 will deactivate the switch 33 and 34 such that the venting valve 16 will close and the air inlet valve 17 will open and in communication with the air tube 10. High pressure air will enter the pressure tank 18 such that the water in the tank is provided with a high pressure. Thus sea water in the tank is provided with pressure and flows to the water pipe 20 (shown in FIG. 2) via a discharging tube 19 and the water in the reverse osmosis tube 21 is also provided with the same pressure for osmosis function.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method of desalination of sea water comprising the steps of
(a) drawing a stream of sea water into a supplying tank;
(b) passing a high pressure air via the top end of the supplying tank;
(c) delivering sea water of step (a) to a pressure tank; and
(d) performing desalination via a plurality of reverse osmosis films.

2. An apparatus for desalination of sea water comprising a supplying tank, a pressure tank, a water pressure energy source and a plurality of reverse osmosis films, wherein the supply tank is provided with a venting valve and an air inlet valve at the top end of the supply tank and the bottom end of the supply tank is provided with a switch, the top end of the venting valve is in communication with the atmospheric pressure, and the top end of the inlet valve is connected to an air tube and is then connected to an air tube and then connected to a high pressure air supply source, the top end of the supplying tank is provided with a float and is secured to the wall of the tank with a support seat having an interlining rod so that the float can be swung, the top of the float is provided with a pressing block and when water in the tank is a full height, the air inlet valve allows air to enter so as to produce pressure, and the other end of the float is hooked with a sloping face hook and one end of the sloping face is secured at the top housing of tank wall by the support seat and the other end of the sloping face is connected to a rope having being connected to another float at the lower end of the tank, the float is secured to the tank wall at the bottom section by means of the support seat so that the float can be swung, when the water in the tank is lowered to the bottom section, the float will lower and the cable is pulled and the inter-linking rod is removed from the sloping face and the air valve is opened.

3. The apparatus of claim 2, wherein the pressure tank is provided with a venting valve and an air inlet valve, and the bottom end of the pressure tank is provided with a valve, the top end of the venting valve is in communication with the atmosphere, and the top end of the air inlet valve is connected to a air tube and is then connected to a high pressure air source, the top end of the pressure valve is provided with an anti-reverse flow valve to withdraw seat water to the supplying tank, the top end of the tank is provided with a float and the float is secured to the tan wall by a support seat having an inter-linking rod so that the float can be swung, the top of the float is provided with a pressing block, thereby when the water in the tank is at the full height position, the pressing blocks trigger the valve having two air valves, and the air inlet valve allows air to enter to produce a pressure, and at the same time, the inter-linking rod of the float is hooked by a sloping face, and one end of the sloping face is secured to the top housing of the tank wall by a support seat, and the other end of the sloping face is connected to a rope and the rope is then connected to another float at the bottom end of the tank, and the float is secured to the tank wall at the bottom section by the support seat having an inter-linking rod so that the float can be swung, when the water in the tank is lowered to the bottom section, the float at the bottom section pulls the rope and the sloping face is removed so that the hooked inter-linking rod is lowered and the air valve is released.

4. The apparatus of claim 1, wherein the pressure tank is provided with an output tube connected to a plurality of reverse osmosis films.
